(19) United States
(12) Patent Application Publication
(10) Pub. No.: US 2011/0216018 A1
(43) Pub. Date: Sep. 8, 2011

(54) FLAT PANEL DISPLAY INTEGRATED WITH TOUCH SCREEN PANEL

(75) Inventors: Dae-Hyun KIM, Yongin-city (KR); Jin-Woo Park, Yongin-city (KR); Ryan Choi, Yongin-city (KR)

(73) Assignee: Samsung Mobile Display Co., Ltd., Yongin-city (KR)

(21) Appl. No.: 12/877,154

(22) Filed: Sep. 8, 2010

(30) Foreign Application Priority Data
Mar. 5, 2010 (KR) 10-2010-0019902

(51) Int. Cl. G06F 3/041

(52) U.S. Cl. 345/173

(57) ABSTRACT

A touch screen panel is directly formed on an upper substrate of a flat panel display which provides a flat panel display integrated with the touch screen panel with an improved yield and reliability by improving ESD defect prevention due to the introduction of electrostatic by using a shield member covering sensing lines so that the sensing lines formed in a non-display region of the touch screen panel are not exposed to the outside.

### CROSS-REFERENCE TO RELATED APPLICATION

This application claims the benefit of Korean Patent Application No. 10-2010-0019902, filed Mar. 5, 2010 in the Korean Intellectual Property Office, the disclosure of which is incorporated herein by reference.

### BACKGROUND

1. Field

Embodiments of the invention relate to a flat panel display, and more particularly, to a flat panel display integrated with a touch screen panel.

2. Description of the Related Art

A touch screen panel is an input device that selects contents displayed on a screen (such as an image display device, etc.) using a hand or an object to input commands of a user. To this end, the touch screen panel is provided on a front face of the image display device and converts positions directly contacting a person's hand or an object into electrical signals. Therefore, the command contents selected at the contact position are received as the input signals.

As the touch screen panel can replace a separate input device that is operated by being connected with the image display device such as a keyboard and a mouse, the use field of the touch screen panel is being expanded gradually. There are multiple types of the touch screen panel: a resistive type, a light sensing type, and a capacitive type, and so on. Among those, the capacitive type of touch screen display converts contact positions into electrical signals by sensing the change in capacitance formed by a conductive sensing pattern, other sensing patterns around the conductive sensing pattern, or a ground electrode, when a person's hand or other object contacts the touch screen panel.

The touch screen panel is generally configured to be attached to the outer surface of the flat panel display. Examples of the flat screen display include a liquid crystal display or an organic light emitting display. When a separately manufactured touch screen panel bonded to the flat panel display is used, there are problems in that the entire thickness of the product is increased and the manufacturing cost is increased.

### SUMMARY

Embodiments of the invention relate to a structure that a touch screen panel is directly formed on an upper substrate of a flat panel display.

An embodiment of the present invention is to provide a flat panel display integrated with a touch screen panel with the improved yield and reliability by improving ESD defect due to the introduction of electrostatic, by including a shield member covering sensing lines to prevent the sensing lines formed in a non-display region of the touch screen panel from exposing to the outside.

According to an embodiment of the present invention, there is provided a flat panel display integrated with a touch screen panel including: an upper substrate and a lower substrate that are each partitioned into a display region and a non-display region formed at the outside of the display region; first and second sensing patterns that are formed on the display region of the upper substrate; sensing lines that are formed on the non-display region of the upper substrate and are electrically connected to the first and second sensing patterns; a shield member that is formed on a region overlapping with the sensing lines formed in the non-display region; and a transparent member that is positioned on a region overlapping with the display region.

According to an aspect of the invention, the transparent member is a polarizer and a window glass.

According to an aspect of the invention, the shield member is formed in one body by extending the transparent member into the non-display region in which the sensing lines are formed or the shield member is formed to be separate from the transparent member, and is made of a non-conductive acrylic resin material or an UV curable resin material.

According to an embodiment of the invention, the flat panel display integrated with the touch screen panel further includes connection patterns that connect the second sensing patterns on the display region of the upper substrate; and a first insulating layer that is formed between the connection pattern and the sensing pattern and a second insulating layer that is formed on the sensing patterns.

According to an embodiment of the invention, the first sensing patterns are configured to include first sensing cells that are disposed in one column having the same X coordinates along a first direction and a first connection line that connects the first sensing cells adjacent to each other and the second sensing patterns are configured to include second sensing cells disposed in one row having the same Y coordinates along a second direction.

According to an embodiment of the invention, the flat panel display integrated with the touch screen panel further includes a plurality of metal patterns that are disposed at an edge of a region in which the first and second sensing patterns are formed and electrically connect the sensing patterns in one column or row unit to the sensing lines.

According to an embodiment of the invention, the plurality of connection patterns and metal patterns are formed on the same layer and are made of materials having a resistance value lower than materials forming the first and second sensing patterns.

According to an embodiment of the invention, the lower substrate is configured to include a display region in which a plurality of pixels including an organic light emitting element configured of a plurality of first electrodes, an organic layer, and a second electrode are formed and a non-display region that is positioned at the outside of the display region and includes a driving circuit to drive the plurality of pixels.

According to the embodiment of the present invention, in the touch screen panel integrally formed on the upper portion of the flat panel display, it includes the shield member covering the sensing lines to prevent the sensing lines formed in the non-display region of the touch screen panel from exposing to the outside so as to improve the ESD defect due to the introduction of static electricity, thereby improving the yield and reliability.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a plan view of an upper substrate of a flat panel display according to an embodiment of the present invention;

FIGS. 2A and 2B are cross-sectional views of specific portions (A-A′ and B-B′) of FIG. 1; and

FIG. 3 is a plan view of a lower substrate of the flat panel display corresponding to FIG. 1.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

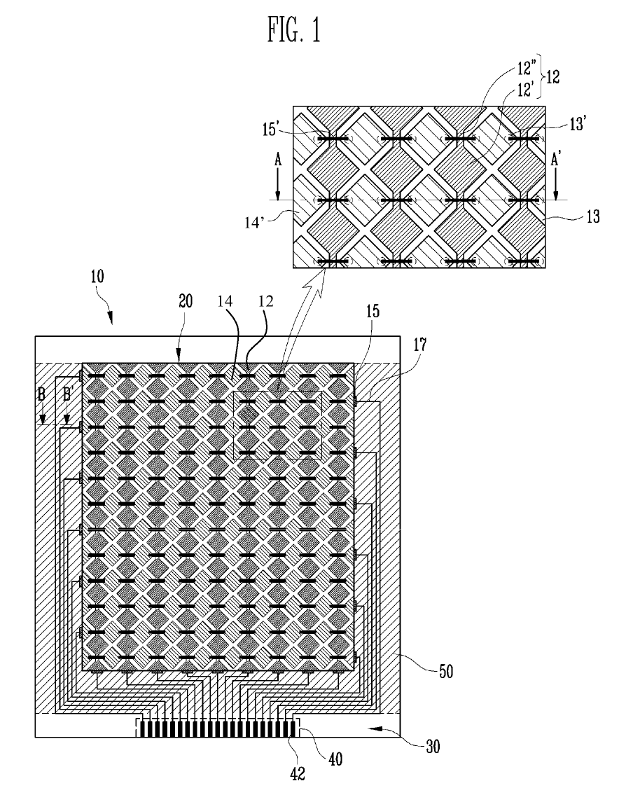

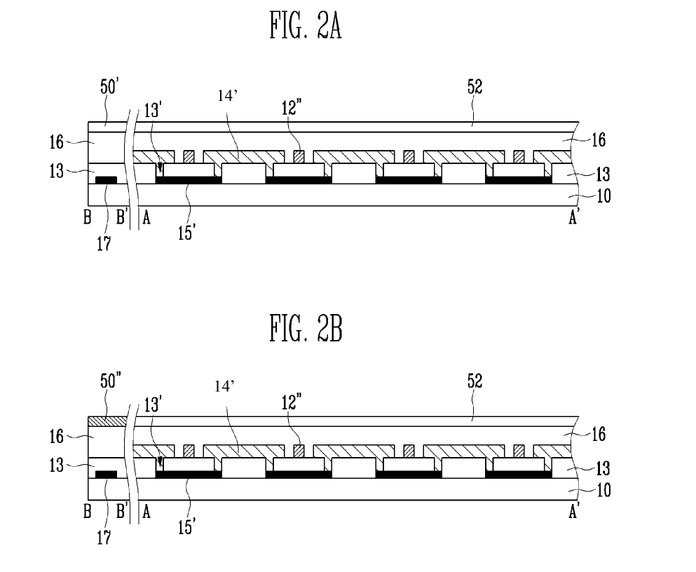

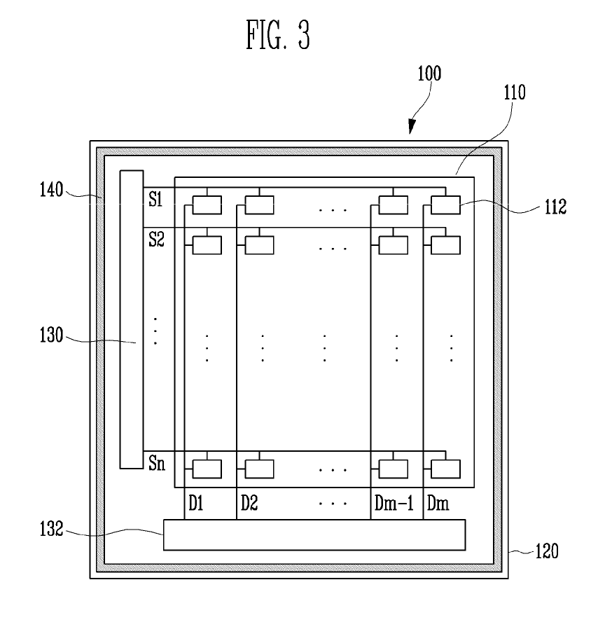

FIG. 1 is a plan view of an upper substrate 10 of a flat panel display according to an embodiment of the present invention and FIGS. 2A and 2B are cross-sectional views of specific portions (A-A′ and B-B′) of FIG. 1. Further, FIG. 3 is a plan view of a lower substrate 100 of the flat panel display corresponding to FIG. 1. Referring to FIGS. 1 through 2B, a touch screen panel according to an embodiment of the present invention is directly formed on an upper substrate 10 of a flat panel display. The flat panel display may be an organic light emitting display or a liquid crystal display. In the exemplary embodiment of the present invention, the organic light emitting display will be described by way of example. However, it is understood that the flat panel display can be other types of displays, such as plasma displays, field emission displays or other types of flat and non-flat displays.

In the shown example using the organic light emitting display, the upper substrate 10 is an encapsulation substrate of the organic light emitting display and is preferably made of a transparent material. The touch screen panel according to the shown embodiment of the present invention includes a plurality of sensing patterns 12 and 14 that are formed on the upper substrate 10, (i.e., the first face of the encapsulation substrate). The touch screen panel further includes metal pads 15 and sensing lines 17 that are electrically connected to the sensing patterns 12, 14.

The region in which the plurality of sensing patterns 12 and 14 are formed is a display region 20 that displays images. The sensing patterns 12, 14 detect touched positions. A non-display region 30 is outside of the display region 20 and includes a flexible printed circuit (FPC) bonding pad part 40, the metal pads 15 electrically connected to the sensing patterns 12 and 14, the sensing lines 17 connected to the metal pads 26, and a plurality of bonding pads 42 connected to each of the sensing lines 17. The FPC bonding pad part 40 includes the bonding pads 42.

In addition and shown in FIG. 3, a second face of the upper substrate 10 corresponding to the non-display region 30 is applied with a sealing material 140 to bond the upper and lower substrates 10 and 100 of the organic light emitting display. In other words, the sealing material 140 is formed between the upper substrate 10 and the lower substrate 100 to perform a role of sealing the display regions 20 and 110 so as to prevent the infiltration of external air into the area between the display regions 20, 110.

As shown, the lower substrate 100 includes the display region 110. The display region 110 includes a plurality of pixels 112, each including an organic light emitting element. The organic light emitting element includes the plurality of first electrodes, the organic layer, and the second electrodes. The non-display region 120 is formed at the outside of the display region 110.

As shown, the display region 110 is a region that displays predetermined images through light emitted from the organic light emitting elements. The display region 110 includes a plurality of scan lines S1 to Sn arranged in a row direction and a plurality of data lines D1 to Dm arranged in a column direction. The display region 110 is provided with the plurality of pixels 112 to which signals are applied from driving circuits 130 and 132. The driving circuits 130 and 132 drive the organic light emitting elements and apply the signals to the scan lines S1 to Sm and the data lines D1 to Dm.

The non-display region 120 is a region provided at the outside of the display region 110 and includes the driving circuits 130, 132. The sealing material 140 bonds the lower substrate 100 and the upper substrate 10 to separate the display regions 20, 110 from the non-display regions 30, 120. As shown, the driving circuit 132 is a data driving circuit 132, and the driving circuit 130 is a scan driving circuit 130. In other words, the display region 110 of the lower substrate 100 overlaps with the display region 20 of the upper substrate 10, and the non-display region 120 of the lower substrate 100 overlaps with the non-display region 30 of the upper substrate 10.

Further, the sensing patterns 12, 14 formed on the display region 20 of the upper substrate 10 are alternately disposed. The sensing patterns 12, 14 are formed to be connected to each other in one column unit having the same X coordinates and in one row unit having the same Y coordinates. In other words, the first sensing patterns 12 are configured to include first sensing cells 12′ that are disposed in one column having the same X coordinates along a first direction (column direction) and a first connection line 12″ that connects adjacent pairs of the first sensing cells 12′. The second sensing patterns 14 are configured to include second sensing cells 14′ are disposed between the first sensing patterns 12 and are connected in one row having the same Y coordinates along a second direction (row direction). As shown, adjacent pairs of the second sensing cells 14′ are connected using a connection pattern 15′ extending across the first connection line 12″.

In the shown embodiment of the present invention, the first sensing patterns 12 and the second sensing patterns 14 are formed on the same layer. Further, the first and second sensing patterns 12 and 14 should be made of a transparent material to implement the operation of the touch screen panel. Therefore, it is preferable (but not required) that the first and second sensing patterns 12 and 14 are made of a transparent conductive material. An example of the conductive material can be, for example, indium tin oxide (hereinafter, ITO). However, the invention is not limited thereto.

Further, in order for the first sensing patterns 12 and the second sensing patterns 14 to serve as the sensing electrode, the sensing cells 12′, 14′ arranged in the first direction and the second direction should be electrically connected to each other. The first sensing cells 12′ are electrically connected to each other by the first connection line 12″. However, since the second sensing cells 14′ forming the second sensing patterns 14 are formed on the same layer as the first sensing cells 12′, the connection line intersecting with the first connection line 12′ may not be formed on the same layer in order to avoid short with the first connection line 12′. Therefore, in the shown embodiment of the present invention, each connection pattern 15′ electrically connecting each of the second sensing cells 14′ to each other is formed on a layer different from the first and second sensing patterns 12, 14. That is, the connection patterns 15′ are formed on the lower layer of the first and second sensing patterns 12 and 14. As shown, the connection patterns 15′ and the sensing lines 17 are both disposed on the substrate 10 and are of the same material. However, the invention is not limited thereto.

In the touch screen panel according to the shown embodiment of the present invention, the connection patterns 15′ are formed on the transparent substrate as the upper substrate 10 and a first insulating layer 13 is formed on the transparent substrate 11 including the connection pattern 15′. While not required in all aspects, the connection patterns 15′ may be made of ITO like the first and second sensing patterns 12 and 14, or may be made of a metal material having resistance value lower than the ITO. Although the connection pattern 15′ may be formed in a rectangular bar shape as shown, the shape is not limited thereto. An end of each connection pattern 15′ is exposed by a contact hole 13′ through the insulating layer 13. The end may have a width which is wider than the width of the other portion of the connection pattern 15′.

As shown, while separated by the first insulating layer 13, the connection patterns 15′ cross the first connection lines 12″ of the first sensing patterns 12. Accordingly, it is preferable to minimize the width of the connection pattern 15′ in order to reduce the effect of parasitic capacitance occurring at this crossing point. However, when minimizing the width of the connection pattern 15′, the line resistance of each of the sensing patterns 14 is increased. This reduces the sensing sensitivity implementing the function of the touch screen panel. Therefore, it is more preferable that the connection pattern 15′ is made of a conductive material having low resistance. However, it is understood that other mechanisms can be used to reduce the line resistance.

In the shown embodiment, the connection pattern 15′ is formed at an edge region of the region in which the first sensing patterns 12 and the second sensing patterns 14 are formed and is made of the same material as the metal pad 15 supplying the sensed signals to the driving circuit (not shown) side and is formed on the same layer as the metal pad 15 through the same process. Thus, an additional mask process to form the connection pattern 15′ is not needed. Therefore, the connection pattern 15′ is not made of the same transparent conductive material as the first and second sensing patterns 12 and 14, thereby making it possible to prevent the increase in the line resistance as well as overcome a disadvantage of adding the mask process in order to forming the connection pattern 15′. However, it is understood that the connection pattern 15′ can be formed in other layers, and need not be of the same material as the metal pad 15.

A second insulating layer 16 is formed on the first and second sensing patterns 12 and 14. The first and second insulating layers 13 and 16 are generally made of inorganic materials, such as silicon oxide (SiO2) and are formed at a thickness of 2000 to 4000 μm, which is too thin to prevent the defect due to an electro-static discharge (ESD) introduced from the outside.

In particular, the first and second insulating layers 13 and 16 are not formed on the FPC bonding pad part 40 in the non-display region 30. Therefore, the sensing lines 17 adjacently formed to the FPC bonding pad part 40 may be exposed to the outside. As such, when the ESD is introduced from the outside by static electricity, etc., current flows to a portion having the lowest impedance and is applied to the sensing cell formed in the display region 20 through the exposed sensing lines 17. Thus, the defect may occur, such as a defect due to a short between the connection pattern 15′ and the first connection line 12″ which crosses above the connection pattern 15′.

In order to overcome the this problem, the shown embodiment of the present invention includes a shield member 50 covering the sensing lines 17 so that the sensing lines 17 formed in the non-display region 30 are not exposed to the outside. As shown in FIG. 1, the shield member 50 overlaps a portion of the non-display region 30 on which the sensing lines 17 are formed. That is, the sensing lines 17 are covered by the shield member 50 and not exposed to the outside. While not required in all aspects, the shield member 50 does not cover other portions of the non-display region 30 on which the sensing lines 17 are not formed. However, it is understood that the shield member 50 could cover all areas of the non-display region 30 in other aspects of the invention.

As described above, the shield member 50 is formed to cover the sensing lines 17, thereby making it possible to prevent the ESD from being introduced through the sensing line. In the case of the embodiment of the present invention shown in FIG. 2A, the shield member 50′ is formed in one body with a transparent member 52 by extending from the transparent member 52 formed on the display region 30 of the touch screen panel. In another embodiment shown in FIG. 2B, the shield member 50 is a separate member 50″ separately formed on the non-display region 30 overlapping with the sensing lines 17. In this embodiment, the shield member 50 can be made of materials different from the materials used in the transparent member 52.

In other words, referring to the embodiment shown in FIG. 2A, the shield member 50′ and the transparent member 52 are formed in one body whereby the shield member 50′ extends from the transparent member 52 formed on the display region 30 of the touch screen panel into the non-display region 30 in which the sensing lines 17 are formed. At this time, the transparent member 52 may be a polarizer or a window glass, but the invention is not limited thereto.

Further, referring to the embodiment shown in FIG. 2B, the shield member 50″ is separated from the transparent member 52 and is formed on the non-display region 30 overlapping with the sensing lines 17. In this embodiment, the shield member 50″ can be made of materials different from the transparent member 52. The shield member 50″ may be made of a non-conductive acrylic resin material or a UV curable resin material, whereas the transparent member 52 may be a polarizer or a window glass, but the invention is not limited thereto. Also, while shown as being used separately, it is understood that both shield members 50′ and 50″ can be used together in another embodiment, such as where the shield member 50′ extends only from one side of the transparent member 52 and the shield member 50′ is disposed on another side of the transparent member 52.

The following Table 1 includes experimental data shown ESD evaluation results for the case where the shield member 50 is provided and the case where the shield member 50 is not provided. The experimental data was obtained from an experiment in which a number of evaluated shield members is 10, a number of touch screen panels is 4, and ±2 kV, ±4 kV, ±6 kV, ±8 kV is each applied to the edge portion (i.e., non-display region 30 having the sensing lines 17) 5 times (evaluation standard, contact discharge, R=330Ω, C=150 Pf). The shield member 50 used in the experiment corresponds to the embodiment shown in FIG. 2A in which the shield member 50 is implemented by the shield member 50′, which extends to the non-display region 30 from the transparent member 52 to cover the sensing lines 17. The transparent member 52 is the polarizer in the experiment.

TABLE 1

| Division | Test | ±2 kV | ±4 kV | ±6 kV | ±8 kV |
|---|---|---|---|---|---|
| No shield | Contact | OK | Touch | — | — |
| member | | | defect | | |
| | | OK | Touch | — | — |
| | | | defect | | |
| | | OK | Touch | — | — |
| | | | defect | | |
| Shield | Contact | OK | OK | OK | OK |
| member | | OK | OK | OK | OK |
| 50 | | OK | OK | OK | OK |

Referring to the results Table 1, the shield member 50′ is formed to overlap with the sensing lines 17 of the non-display region 30, thereby making it possible to confirm the improvement of the ESD defect. In other words, when there is no shield member, the defect does not occur at the ESD level having about 2 kV, and defects occur thereafter. In contrast, where the shield member 50′ is used, it is possible to initially secure 8 Kv or more without the ESD defect.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A flat panel display integrated with a touch screen panel comprising:
an upper substrate and a lower substrate disposed opposite the upper substrate, each of the upper and lower substrates comprising a display region and a non-display region at the outside of the display region;
first and second sensing patterns in the display region of the upper substrate;
sensing lines in the non-display region of the upper substrate and which are electrically connected to the first and second sensing patterns;
a shield member on a region of the non-display region of the upper substrate and overlapping the sensing lines formed in the non-display region; and
a transparent member that is positioned on a region overlapping with the display region.

2. The flat panel display integrated with the touch screen panel of claim 1, wherein the transparent member is a polarizer and/or a window glass.

3. The flat panel display integrated with the touch screen panel of claim 1, wherein the transparent member and the shield member comprise one body in which the shield member extends from the transparent member into the non-display region in which the sensing lines are formed.

4. The flat panel display integrated with the touch screen panel of claim 1, wherein the shield member is formed separately from the transparent member, and comprises a non-conductive acrylic resin material or an UV curable resin material.

5. The flat panel display integrated with the touch screen panel of claim 1, further comprising:
connection patterns that connect the second sensing patterns on the display region of the upper substrate; and
a first insulating layer formed between the connection patterns and the first sensing patterns; and
a second insulating layer that is formed on the first and second sensing patterns.

6. The flat panel display integrated with the touch screen panel of claim 1, wherein the first sensing patterns include first sensing cells that are disposed in one column having a same X coordinate along a first direction and a first connection line that connects adjacent pairs of the first sensing cells in a same column.

7. The flat panel display integrated with the touch screen panel of claim 6, wherein the second sensing patterns are configured to include second sensing cells disposed in one row having a same Y coordinates along a second direction.

8. The flat panel display integrated with the touch screen panel of claim 7, further comprising metal patterns that are disposed at an edge of a region in which the first and second sensing patterns are formed and electrically connect the first and second sensing patterns in one column or row unit to the sensing lines.

9. The flat panel display integrated with the touch screen panel of claim 8, further comprising connection patterns that connect the second sensing patterns on the display region of the upper substrate, wherein the connection patterns and the metal patterns are formed on a same layer and are made of materials having a resistance value lower than materials forming the first and second sensing patterns.

10. The flat panel display integrated with the touch screen panel of claim 1, wherein:
the display region of the lower substrate includes a plurality of pixels including corresponding organic light emitting elements, each organic light emitting element including a first electrode, an organic layer, and a second electrode, and
the non-display region of the lower substrate includes a driving circuit to drive the plurality of pixels.

11. A flat panel assembly comprising:
a flat panel display comprising a substrate comprising a display region in which images are displayed and a non-display region at the outside of the display region;
sensing patterns in the display region of the substrate which sense a touch on the display region;
sensing lines in the non-display region and which are electrically connected to the sensing patterns;
a shield member disposed in the non-display region to cover the sensing lines; and
a transparent member that covers the display region.

12. The flat panel assembly of claim 11, wherein the shield member is connected to and extends from the transparent member.

13. The flat panel assembly of claim 12, wherein the shield member and the transparent member are made of a same material.

14. The flat panel assembly of claim 12, wherein the shield member and the transparent member are made of different materials.

15. The flat panel assembly of claim 14, wherein the shield member comprises a non-conductive acrylic resin material or an UV curable resin material, and the transparent member comprises a polarizer and/or a window glass.

16. The flat panel assembly of claim 12, further comprising a sheet comprising a first region including the shield member and a second region comprising the transparent member.

17. The flat panel assembly of claim 11, wherein:
the sensing patterns comprise first sensing patterns connected in a first direction and second sensing patterns connected in a second direction other than the first direction, and
the sensing lines comprise first sensing lines extending from the first sensing patterns in the non-display region and second sensing lines extending from the second sensing patterns in the non-display region.

18. The flat panel assembly of claim 17, wherein:
the first sensing patterns comprise first sensing cells and first connecting elements connecting adjacent pairs of the first sensing cells, the first connecting elements being disposed on the substrate;
the second sensing patterns comprise second sensing cells and second connecting elements connecting adjacent pairs of the second sensing cells, the second connecting elements being disposed above the first connecting elements, and
the flat panel assembly further comprises an insulating layer disposed between the substrate and the first and second sensing cells and separating the first and second connecting elements, the first sensing cells being connected to the first connecting elements through corresponding through holes in the insulating layer.

19. The flat panel assembly of claim 18, further comprising another insulating layer disposed between the transparent member and the first and second sensing patterns

20. The flat panel assembly of claim 18, wherein the sensing lines are disposed on the substrate.

21. The flat panel assembly of claim 18, wherein sensing patterns and sensing lines are formed by
forming the first connecting elements and the sensing lines on the substrate;
forming an insulating layer covering the display region and the formed first connecting elements;
forming the through holes in the insulating layer to expose corresponding ends of the formed first connecting elements;
forming the first and second sensing patterns on the insulating layer;
connecting the first sensing patterns to the first connecting elements through the through holes; and
forming the second connecting elements on the insulating layer above the first connecting elements and between adjacent pairs of the through holes.

22. The flat panel assembly of claim 11, wherein the flat panel display further comprises:
another substrate having a first region including a plurality of pixels which generate the images displayed in the display region and a second region including a driving circuit to drive the plurality of pixels; and
a seal which seals the substrate to the another substrate such that the pixels are disposed between the display region and the first region, and the driving circuit is disposed between the non-display region and the second region.
